(19) United States
(12) Patent Application Publication
(10) Pub. No.: US 2013/0071179 A1
(43) Pub. Date: Mar. 21, 2013

(54) Fastening Device for Attachment to a Mounting Rail

(71) Applicants: Peter Mugg, Nueziders (AT); Thomas Merhar, Schaan (LI)

(72) Inventors: Peter Mugg, Nueziders (AT); Thomas Merhar, Schaan (LI)

(21) Appl. No.: 13/422,009

(22) Filed: Mar. 16, 2012

(30) Foreign Application Priority Data
Mar. 16, 2011 (DE) 102011005598.3

(51) Int. Cl. F16B 2/18; F16B 5/10; F16B 7/04

(52) U.S. Cl. CPC F16B 2/18; F16B 7/044; F16B 5/10
USPC 403/327

(57) ABSTRACT

In a fastening device for attachment to a mounting rail, comprising a toggle element for introduction into a mounting opening and engagement on the back of edges of the mounting opening of the mounting rail, a bracing device that works together with the toggle element, especially a clamping bolt, for clamping the fastening device on the mounting rail, a contact plate for outside contact on the mounting rail that has a pass-through opening for at least one part of the bracing device, a spring as compression and torsion spring, a holding device between the toggle element and the contact plate for holding the toggle element in the braced position, whereby during loosening of the holding device, the toggle element may be transferred by the spring from an introduction position to a braced position in engagement with one of the edges of the mounting opening.

### CROSS-REFERENCE TO RELATED APPLICATIONS

The present application claims priority to German Patent Application DE 10 2011 005 598.3, filed Mar. 16, 2011, and entitled “Befestigungsvorrichtung zur Anordnung an einer Montageschiene” (“Fastening Device for Attachment to a Mounting Rail”), which is hereby incorporated by reference in its entirety.

### BACKGROUND OF THE INVENTION

The present invention generally relates to a fastening device.

In the area of housing technology, rails are used on which lines, e.g. for water, heating, ventilation, air conditioning and/or electrical installations may be fastened simply using corresponding fastening devices, for example with pipe clamps and pushbuttons. On rail systems, devices are also provided for suspending components having rod elements that may also be fastened to the rail systems with suitable fastening devices. For connecting several rail elements, fastening devices are also used that have, e.g., angled elements as contact plates.

So-called C-shaped mounting rails are often used for such a rail system, as are known from DE 87 15 256 U1. The interior space surrounded by the mounting rail is accessible from the outside along an installation opening that runs longitudinally along the mounting rail and is bordered on the sides by edges. The installation opening has an inner width running perpendicular to the longitudinal extension of the mounting rail that is smaller than the corresponding inner dimension of the interior space of the mounting rail.

A fastening device of this general type is known from DE 10 2009 000786. A spring as pressure and torsion spring may only be handled with difficulty during installation, since the pressure section and the torsion section are not separated from each other on the spring.

### BRIEF SUMMARY OF THE INVENTION

A system and method for a fastening device for attachment to a mounting rail, the fastening device including a toggle element for introduction into a mounting opening and engagement on the back of edges of the mounting opening of the mounting rail, a bracing device that works together with the toggle element, especially a clamping bolt, for clamping the fastening device on the mounting rail, a contact plate for outside contact on the mounting rail that has a pass-through opening for at least one part of the bracing device, a spring as compression and torsion spring, a holding device between the toggle element and the contact plate for holding the toggle element in the braced position, whereby during loosening of the holding device, the toggle element may be transferred by the spring from an introduction position to a braced position in engagement with one of the edges of the mounting opening.

### BRIEF DESCRIPTION OF THE DRAWINGS

In the following, an exemplary embodiment of the invention is described in more detail with reference to the attached drawings. In the drawings:

FIG. 1 shows the fastening device for connecting two mounting rails,

FIG. 2 shows one view of a fastening device mounted on a mounting rail,

FIG. 3 shows a toggle element of the fastening device shown in FIG. 2,

FIG. 4 shows a side view of the toggle element according to FIG. 3,

FIG. 5 shows a cross section through a contact plate of the fastening device shown in FIG. 2 and

FIG. 6 shows a perspective view only of the second sleeve section of the contact plate according to FIG. 5 with a spring.

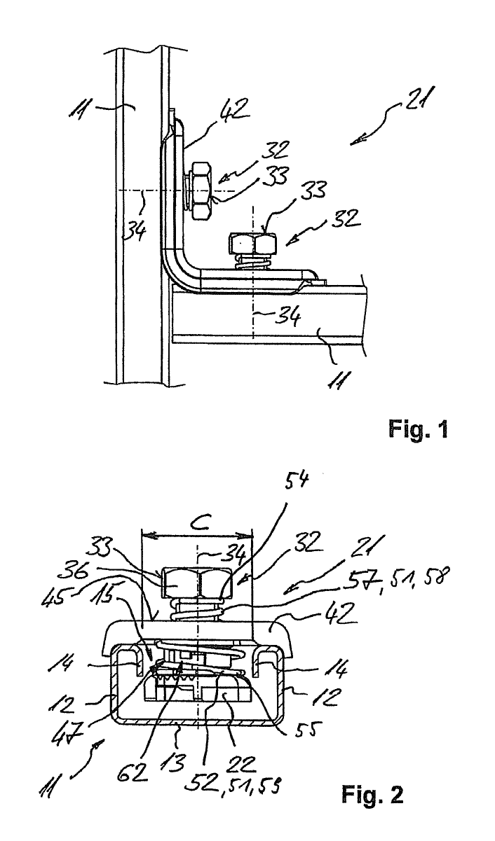

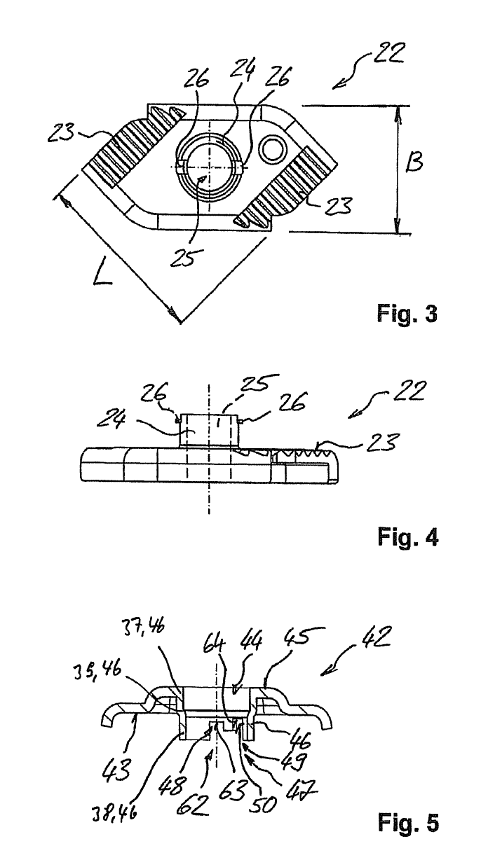

### DETAILED DESCRIPTION OF THE INVENTION

One aspect of one or more embodiments of the present invention includes making available a fastening device in which, during production, the spring may be installed easily with little effort.

This is achieved with a fastening device for mounting on a mounting rail comprising a toggle element for introduction into the installation opening and engagement of edges of the installation opening of the mounting rail, a clamping device that works together with the toggle element, especially a clamping bolt for clamping the fastening device to the mounting rail, a contact plate for contact on the outside of the mounting rail which has an introduction opening for at least one part of the clamping device, a spring as pressure and torsion spring, a holding device between the toggle element and the contact plate for holding the toggle element in the prestressed position, whereby when the holding device is released the toggle element is transferred by the spring from the introduction position into a braced position engaged in the edges of the mounting opening, whereby the spring is held in a fixed position between a first end and a second end of the spring, locked in rotation with respect to the contact plate. The one-part torsion spring is held in the fixed position locked so that it will not rotate with respect to the contact plate, thus on the rotation spring, a pressure section is clearly separated from a torsion section. The pressure section thus acts only as compression spring and the torsion section acts only as torsion spring. This means that installing the spring on the fastening device is significantly simplified.

In particular, the spring has a first end and a second end and, between the fixed position and the first end the spring has, especially exclusively, a pressure section as a second spring element that acts as a compression spring and between the fixed position and the second end, especially exclusively, has a torsion section as a first spring element that acts as a torsion spring or that acts as a torsion spring and may also apply a tensile force. Thus the spring is clearly separated into a pressure section that acts exclusively as compression spring or tension spring and a torsion section that acts exclusively as torsion spring. Thus during installation of the spring, it is only necessary to apply a torque to the torsion section for torsion prestress of the torsion section and on the pressure section it is only necessary to apply a pressure force for pressure prestress of the pressure section. Thus, during installation, in an advantageous manner it is not necessary to apply any torsion prestress to the pressure section and in the same way, it is not necessary to apply any pressure force to the torsion section.

In another design, the first end is positioned in the area of a bolt head of the clamping bolt and the second end in the area of the toggle element and/or the spring lies with its second end on the toggle element and/or the spring is designed with the pressure and torsion section is a single part. With a one-part spring with the pressure and torsion section that are designed separately on the spring, in an advantageous manner only one spring has to be made available for the fastening device. This makes installation easier.

In an extended embodiment, the spring is held so it will not turn with respect to the contact plate by radially feeding a spring wire through a notch on a second sleeve section of the contact plate. As torsion spring, the spring has a helical-shaped spring wire and the spring wire is guided through a notch on the second sleeve section. At this notch, the spring wire contacts the sleeve section and, because of this, there may be no rotation of the spring wire at the notch so in this way the spring wire is held on the notch so it cannot turn.

Preferably, the second sleeve section of the contact plate has a first section with a smaller diameter and a second section with a larger diameter and the first and second sections are connected to each other with a conical narrowing section of the second sleeve section.

In one variant, the fixed position is formed in the area of the conical narrowing section.

Advantageously, the spring contacts the conical narrowing section with an axial pressure force so the pressure section of the spring ends in axial direction on the conical narrowing section.

In another embodiment, the spring cannot apply any torque on the toggle part with its pressure section since the spring is held so it is locked against rotation with respect to the contact plate at the fixed position.

In particular, a torque may only be applied to the toggle element with the torsion section of the spring.

In another embodiment, the spring is designed as a coil spring, especially with a smaller diameter on the pressure section as second spring element and a larger diameter on the torsion section as first spring element.

Advantageously, at least one contact element with a contact surface is provided on the contact plate for limiting the rotation capability of the toggle element.

In another embodiment, the at least one contact element projects from the contact side of the contact plate turned toward the toggle element.

In one variant, the holding device for the toggle element is provided on the contact element.

In an additional embodiment, a guide contour is provided for the toggle element between the holding device and one free end of the contact element.

Preferably, on a side of the toggle element turned toward the contact plate, a first, cylindrical sleeve section is provided and on a contact side of the contact place turned toward the toggle element a second sleeve section is provided that surrounds the passage opening, whereby the first sleeve section and the second sleeve section are arranged so they may telescope with respect to each other and whereby the at least one contact element is provided on the second sleeve section of the contact plate.

In another embodiment, the contact element comprises a first latching structure for aligning the toggle element in its introduction position and at least one second latching structure for aligning the toggle element in its braced position, whereby at least one counter-latching structure is provided on the toggle element for engaging in the latching structure according to the alignment of the toggle element.

In particular, a second spring element is provided between one section of the bracing device on its end turned away from the toggle element and the contact plate to exert stress on a part of the bracing device connected to the toggle element in the direction of the end turned away from the toggle element.

Turning now to the Figures, the mounting rails 11 each have two side walls 12 lying opposite each other, a rear wall 13 connecting these side walls 12 and a mounting opening 15 that runs in longitudinal direction of the mounting rail 11 and limited by edges 14 lying opposite this rear wall 13. The mounting opening 15 has an inner width C running perpendicular to the longitudinal extension of the mounting rail 11, which is defined by the free ends of the edges 14 that are bent inward. Each mounting rail 11 surrounds an inner space that is accessible from the outside through the mounting opening 15.

The fastening device 21 has a toggle element 22 with a width B that is less than the inner width C of the mounting opening 15 in the mounting rail 11 and a length L that is greater than the inner width C of the mounting opening 15 in the mounting rail 11. On its clamping surfaces 23, the toggle element 22 is provided with teeth for better engagement with the free ends of the edges 14 of the mounting opening 15, which optionally may also be provided with teeth. From the side of the toggle element 22 with the clamping surface 23, a first cylindrical sleeve section 24 projects, which forms an opening 25 provided with an inner thread for fastening a clamping bolt 33 on the toggle element 22 as a bracing device 32. The clamping bolt 33 connected with the toggle element 22 has a longitudinal axis 34 and is used for clamping the fastening device 21 on the mounting rail 11. Two diametrically opposed tabs project radially outward from the free edge of the first sleeve section 24 as counter-latching structure 26.

In addition, the fastening device 21 has an angled element as contact plate 42, which during the mounting of the fastening device 21 on the mounting rail 11, with its contact side 43 comes in contact with the outside of the mounting rail 11 adjacent to the mounting opening 15 and thus stresses it on its face side. Opposite the contact side 43, the contact plate 42 has a clamping surface 45. The contact plate 42 is also provided with lead-through openings 44 for leading through the shaft 35 of the clamping bolt 33, whereby the shaft 35 may rotate freely in these lead-through openings 44. A second cylindrical sleeve section 46 surrounding the lead-through opening 44 extends from the contact side 43 of the contact plate 42 turned toward the toggle element 22 when the fastening device 21 is in the installed state. In the installed state of the fastening device 21, the first sleeve section 24 on the toggle element 22 and the second sleeve section 46 of the contact 42 telescope at the toggle element 22 so the toggle element is guided securely on the contact plate 42.

Between the contact plate 42 and the toggle element 22, a spring 51 is mounted as a coil spring. In addition a holding device 62 is provided between the toggle element 22 and the contact plate 42 for holding the toggle element 22 in a prestressed position, which corresponds to the introduction position of the toggle element 22. The holding device 62 is formed on one side with a first notch 63, which simultaneously forms a first latching structure 48 of a contact element 47 for alignment of the toggle element 22 in its introduction position, on the free end of the second sleeve section 46 on the contact plate 42 and, on the other, by the tabs as counter-latching structure 26 on the first sleeve section 24 of the toggle element 22. The contact element 47 projects from the contact side 43 of the contact plate 42 turned toward the toggle element 22. Here the contact surface 50 is designed with a second notch 64 formed on the side edge, which is provided on the free edge of the second sleeve section 46, at a distance from the first latching structure 48, as a second latching structure 49 for aligning the toggle element 22 in its braced position. The second notch 64 has a depth that is deeper than the depth of the first notch 63 of the holding device 62 and/or of the first latching structure 48, in each case starting from the free edge of the second sleeve section 46. The holding device 62 for the toggle element 22 is thus provided on the contact element 47. Diametrically opposite the contact element 47, a second contact element 47 that is not shown here is provided on the second sleeve section 46 of the contact plate 42. As explained above, the tabs that project radially outward from the free edge of the sleeve section 24 of the toggle element 22 form the counter-latching structure 26 for engagement into the latching structure 48 and/or 49 according to the alignment and/or position of the toggle element 22.

The spring 51 is arranged between the bolt head 36 and the toggle element 22. The one-part spring 51 has a first spring element 52 as torsion spring and a second spring element 57 as compression spring. The first spring element 52 thus forms a torsion section 59 and/or rotation area 59 of the spring 51 and the second spring element 57 forms a pressure section 58 of the spring 51. The spring element 52 turned toward the toggle element 22 that is arranged below the contact plate 42 forms the rotation area 59 and/or torsion section 59 and the second spring element 57 turned away from the toggle element 22 and arranged above the contact plate 42 forms the pressure area 58 of the one-part spring 51.

During introduction of the toggle element 22 into the mounting opening 15, it is held in an introduction position by the holding device 62. Due to pressure on the bolt head 36 in the direction of the contact plate 42, opposite the pressure force exerted by the pressure section 58 on the bolt head 36 and the contact plate 42 on a conical narrowing section 39, the pressure section 58 of the spring 51 will be compressed axially, the clamping bolt 33 with the toggle part 22 will be moved downward and the engagement of the contact plate 42 with the toggle element 22 will be released so the toggle element 22 will automatically be turned by the first spring element 52 in its braced position for bracing against the edges 14 of the mounting opening 15 due to the torsion prestress of the torsion section 59. The second end 55 of the spring 51 is attached on the toggle element 22 and/or a fixed connection exists between a second end 55 of the spring 51 and the toggle element 22. One edge of the notch 64, which forms the second latching structure 49, forms the contact surface 50 of the contact element 47 and prevents overturning the toggle element 22 in a position relative to the edges 14 of the mounting opening 15 that does not allow/ensure optimal clamping of the fastening device 21 on the mounting rail 11. In this preliminary mounting positioning, the fastening device 21 is held so it is stopped on the mounting rail 11, but may continue to be slid along the mounting opening 15 for repositioning or adjustment. In order to clamp the fastening device 21 on the mounting rail 11, the clamping bolt 33 is screwed into the toggle element 22, whereby the toggle element 22 is moved in the direction of the contact plate 42 and thus comes in contact with the free ends of edges 14 of the mounting opening 15. The depth of the second notch 64 is selected such that an adequately large path is available for the axial movement of the toggle element 22 during the clamping process.

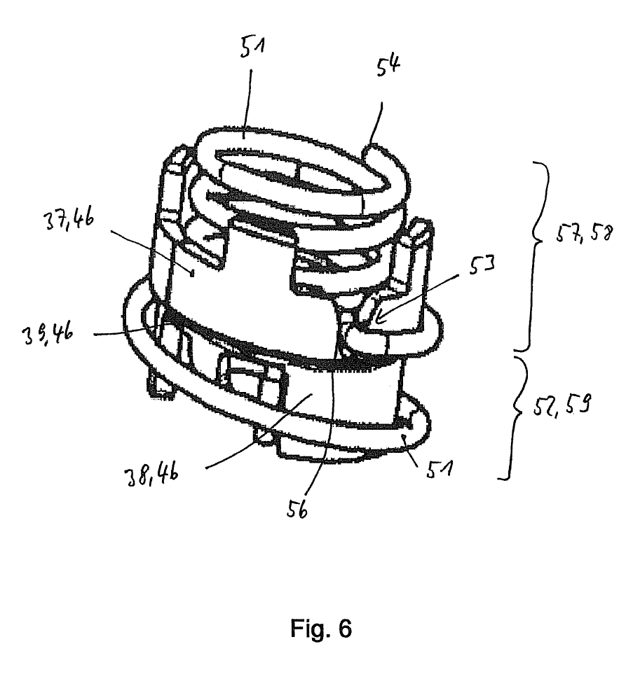

The second sleeve section 46 of the contact plate 42 comprises a first section 37 and a second section 38. The sleeve section 46 that is circular in cross section has a larger diameter on the first section 37 than on the second section 38. The first and second sections 37, 38 are connected to each other by the conical narrowing section 39 of the second sleeve section 46 (FIGS. 5 and 6). The pressure section 58 of the second spring element 57 of the one-part spring 51 lies, at one end, on the conical narrowing section 39, and the bolt head 36 lies on a first end 54 of the spring 51. The second sleeve section 56 has a notch 56 (FIG. 6) and the spring wire of spring 51 is guided through the notch 56 from the pressure section 58 inside an interior space, namely the lead-through opening 44, enclosed by the sleeve section 24 to an outside space radially outward of the second sleeve section 46. Below the notch 56 according to the illustration in FIG. 6, the spring 51 forms the torsion section 59 as first spring element 52. The second end 55 of the spring 51 on the torsion section 59 ends at the toggle element 22 (FIG. 2) and is attached on the toggle element 22 so that with the second end 55 a torque may be applied to the toggle element 22 for turning the toggle part 22 around a rotary angle of essentially 90°. The spring 51 thus has a pressure section 58 that functions exclusively as compression spring and a torsion section 59 that acts exclusively as torsion spring and possibly also as a tension spring. Thus at the notch 56, the spring 51 lies on the second sleeve section 46 and thereby a fixing location 53 forms on the spring 51 in the area of the notch 56, at which the spring 51 is held locked against rotation with respect to the contact plate 42, since the second sleeve section 46 forms one part with it at contact plate 42.

Considered overall, significant advantages are connected with the fastening device 21 according to one or more embodiments of the present invention. The spring 51 is held locked against rotation at the fixed position 53 with respect to the contact plate 42 because of the passage through the notch 56 of the second sleeve section 46 in the area of the conical narrowing section 39. Because of this, on spring 51, the second spring element 57 between the first end 54 and the fixed point 53 and/or the notch 56 acts exclusively as a compression spring and the first spring element 52 between the fixed position 53 and/or the notch 56 and the second end 55 of the spring 51 acts exclusively as torsion spring. Thus during installation of the fastening device 51, no pressure force needs to be exerted on the torsion section 59, rather only a torque has to be applied for torsion prestress of the torsion section 59 and only a pressure force, but no torque, has to be applied to the pressure section 58 during installation of the fastening device 21. Because of this the installation of the one-part spring 51 with the pressure and torsion sections 58, 59 is significantly simplified.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A fastening device for attachment to a mounting rail, said fastening device including:
a toggle element for introduction into a mounting opening and engagement on the back of edges of the mounting opening of the mounting rail;
a bracing device that works together with the toggle element for clamping the fastening device on the mounting rail;
a contact plate for outside contact on the mounting rail that has a pass-through opening for at least one part of the bracing device;
a spring as compression and torsion spring; and
a holding device between the toggle element and the contact plate for holding the toggle element in the braced position, whereby during loosening of the holding device, the toggle element may be transferred by the spring from an introduction position to a braced position in engagement with one of the edges of the mounting opening, by using a torque applied by the spring on the toggle element,
wherein the spring is held in a fixed rotary position between a first end and a second end of the spring so it does not turn with respect to the contact plate.

2. The fastening device according to claim 1 wherein the toggle element is a clamping bolt.

3. The fastening device according to claim 1 wherein the spring, between the fixed position and a first end, has a pressure section as second spring element that acts as a compression spring.

4. The fastening device according to claim 1 wherein the spring, between the fixed position and the second end, has a torsion section as first spring element that acts as a torsion spring.

5. The fastening device according to claim 3 wherein the first end is positioned in the area of the bolt head of the clamping bolt and

6. The fastening device according to claim 3 wherein the second end is positioned in the area of the toggle element.

7. The fastening device according to claim 3 wherein the spring is designed in one part with pressure and torsion sections.

8. The fastening device according to claim 1 wherein the spring is held locked against rotation with respect to the contact plate with a radial lead-through of a spring wire through a notch on a second sleeve section of the contact plate.

9. The fastening device according to claim 1 wherein the second sleeve section of the contact plate has a first section with a smaller diameter and a second section with a larger diameter and the first and second sections are connected to each other with a conical narrowing section of the second sleeve section.

10. The fastening device according to claim 9 wherein the fixed position is formed in the area of the conical narrowing section.

11. The fastening device according to claim 10 wherein the spring contacts the conical narrowing section due to axial pressure force so the pressure section of the spring ends, in axial direction, at the conical narrowing section.

12. The fastening device according to claim 11 wherein no torque may be applied to the toggle element with the pressure section of the spring, because the spring is held locked against rotation with respect to the contact plate at the fixed location.

13. The fastening device according to claim 12 wherein a torque may be applied to the toggle element exclusively by the torsion section of the spring.

14. The fastening device according to claim 1 wherein the spring is designed as a coil spring, especially with a smaller diameter at the pressure section as second spring element and a larger diameter on the torsion section as first spring element.
